(19) United States
(12) Patent Application Publication
(10) Pub. No.: US 2009/0150699 A1
(43) Pub. Date: Jun. 11, 2009

(54) SLEEP SCHEDULING METHOD BASED ON MOVING DIRECTIONS OF TARGET IN SENSOR NETWORK

(75) Inventors: Hyeon Joong CHO, Seoul (KR); Sang Joon PARK, Daejeon-city (KR); Sang Gi HONG, Daejeon-city (KR); Jong Suk CHAE, Daejeon-city (KR); Cheol Sig PYO, Daejeon-city (KR); Bo JIANG, Blacksburg, VA (US); Kai HAN, Blacksburg, VA (US); Binoy RAVINDRAN, Blacksburg, VA (US)

Correspondence Address: CANTOR COLBURN, LLP, 20 Church Street, 22nd Floor, Hartford, CT, 06103, US

(73) Assignee: Electronics and Telecommunications Research Institute, Daejeon-city (KR)

(21) Appl. No.: 12/323,964

(22) Filed: Nov. 26, 2008

Related U.S. Application Data
(60) Provisional application No. 60/991,096, filed on Nov. 29, 2007.

(30) Foreign Application Priority Data
Apr. 30, 2008 (KR) 10-2008-0040804

(51) Int. Cl. G06F 1/32; G06F 9/46; G06N 5/02; G01C 21/10

(52) U.S. Cl. 713/323; 718/102; 706/52; 701/206

(57) ABSTRACT

Provided is a sleep scheduling method based on directions of a target in a sensor network. A track subregion is set as an oval shape that is in proportion to a probability of the target moving in certain directions so as to track the target, and sleep patterns of sensor nodes in the tracking subregion are scheduled in consideration of a probability of the target moving in certain directions. As such, the energy efficiency of each sensor node in the sensor network can be improved.

### CROSS-REFERENCE TO RELATED PATENT APPLICATIONS

This application claims the benefit of U.S. Patent Application No. 60/991,096, filed on Nov. 29, 2007 and Korean Patent Application No. 10-2008-0040804, filed on Apr. 30, 2008 in the Korean Intellectual Property Office, the disclosure of which is incorporated herein in its entirety by reference.

### BACKGROUND OF THE INVENTION

1. Field of the Invention

The present invention relates to a sensor network, and more particularly, to a method of sleep scheduling each sensor node of a sensor network based on moving directions of a target

The present invention is derived from research performed as an IT growth power technology development business of the Ministry of Information and Communication and the Institute of Information Technology Assessment (IITA), Republic of Korea [National management No.: 2005-S-038-03, Title of the subject: Sensor Node Sleep Scheduling Method in Wireless Sensor Network].

2. Description of the Related Art

Mobile target tracking is one of the most traditional applications of a wireless sensor network (WSN), where “tracking” means that when observing a target, a node not only needs to report up to the sink node but also has to make sure to keep tracking without losing. Proactively waking up the neighboring nodes is a commonly used approach for keeping tracking.

Energy efficiency is one of the most critical issues for a sensor network, since a node's power supply is hard to be replaced once deployed. Accordingly, research has been conducted into various methods to improve the energy efficiency of the nodes.

In the past sleep scheduling works, some do not consider the target's movement at all, and others may schedule the sleep pattern based only on the distance of a node from the target's instant position. That is, the closer the node is from the target, the lighter its sleep level should be. In another word, they consider the magnitude of a target's velocity only. Such a sleep algorithm or protocol is usually called “circle-based scheme” or “legacy scheme.” With this scheme, all the nodes in a circle will take the same sleep pattern without distinguishing the difference on moving directions.

However, a target in the real world usually has its purpose, e.g. intruding towards a special goal. And a target, i.e. a vehicle, will be restrained by physics rules. For example, a vehicle engine's maximum power output is fixed, thus the accelerator will decrease as the velocity increases. Therefore the target's movement will follow some specific moving model instead of being totally random. If the target's kinematics is taken into account, not all the nodes in a circle need to be awakened to get prepared, thus the consumed energy could be reduced accordingly. Therefore, if the movement of the target can be predicted, all of the nodes existing in a circle in which the target is positioned do not need to be proactively woken up, and thus energy consumption can be reduced.

### SUMMARY OF THE INVENTION

The present invention provides a method of sleep scheduling sensor nodes for increasing energy efficiency of the nodes by reducing the number of the sensor nodes in an awake state in a sensor network.

According to an aspect of the present invention, there is provided a sleep scheduling method based on directions of a target regarding sensor nodes sensing a position and a speed of the target in a sensor network comprising the sensor nodes, the method comprising: setting a tracking subarea to track the target so that a distance between contour line of the tracking subarea and sensor nodes sensing the target are in proportion to a probability of the target moving in directions; and scheduling sleep patterns of the sensor nodes in the tracking subarea

According to another aspect of the present invention, there is provided a sleep scheduling method in a sensor network comprising sensor nodes sensing a position and a speed of the target, the method comprising: obtaining a distance between a sensor node positioned in a tracking subarea set based on a probability of the target moving in directions and a root node sensing the target; obtaining a minimum time at which the target reaches a sensing region of the sensor node, based on the distance; obtaining an angle formed by the direction of a line connecting the root node and the sensor node and the direction of an instant velocity of the target; setting a maximum duty cycle (DC) that is in proportion to a probability of the target moving in direction corresponding to the angle and the speed of the target, to a DC of the target; and if the sensor node is maintained in a sleep state for a minimum time and reaches the minimum time, maintaining an active state during a DC set for the target.

### BRIEF DESCRIPTION OF THE DRAWINGS

The above and other features and advantages of the present invention will become more apparent by describing in detail exemplary embodiments thereof with reference to the attached drawings in which:

FIGS. 1 and 2 illustrate an example of a target moving probability depending on moving directions of a target in a sensor network;

FIG. 3 is a flowchart illustrating operations of a method of managing a tracking subregion of a target according to an embodiment of the present invention;

FIG. 4 illustrates an example of parameters of sleep levels of sensor nodes according to an embodiment of the present invention;

FIG. 5 illustrates an example of a duty cycle for sleep scheduling based on directions of a target in a sensor network according to an embodiment of the present invention;

FIG. 6 illustrates the characteristics of each of the parameters for sleep scheduling based on directions of a target in a sensor network according to an embodiment of the present invention; and

FIG. 7 is a flowchart illustrating operations of a sleep scheduling method based on directions of a target in a sensor network according to an embodiment of the present invention.

### DETAILED DESCRIPTION OF THE INVENTION

The present invention will now be described more fully with reference to the accompanying drawings, in which exemplary embodiments of the invention are shown.

The following assumptions are made in relation to the present invention.

First, a target tracking field is fully covered by the nodes' sensing radio frequencies.

Second, the sensor nodes' location is known in advance by using various conventional methods.

Third, all of the nodes are homogeneous, and a sensor network is in a flat architecture, and a tracking field is also flat. Thus, a two-dimensional (2D) mesh model is used in the present invention.

Fourth, all of tracking behaviors are completed locally around the target without the sink node's intervention.

Fifth, the sensor nodes can find out a target's position, the instant velocity magnitude, and the moving direction of the target.

A method of sleep scheduling sensor nodes based on moving directions of a target in a sensor network according to an embodiment of the present invention will now be described based on the above-mentioned assumptions with reference to the attached drawings.

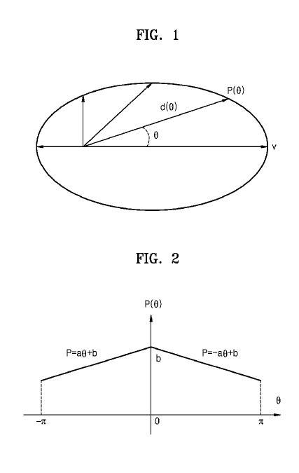

FIGS. 1 and 2 illustrate an example of a target moving probability depending on moving directions of a target in a sensor network.

In the real world, the target will in general move towards a certain direction following certain physics rules. That is, the target moves in the range of a speed v. In addition, the target has a higher probability to keep the current direction (θ=0) than to change to another, and turning around (making a 180 U-turn) has the least probability. According to the present invention, a target moving probability is modeled in consideration of the speed of the target and the moving direction of the target.

FIG. 1 illustrates a normal distribution model of a target moving probability on different directions. In this regard, v represents the instant velocity of a target, and θ represents the instant velocity direction at the current time point, and P(θ) represents the probability the target will move in certain directions, and the area of the ellipse-like contour is 1. FIG. 2 illustrates a linear model of the target moving probability according to an embodiment of the present invention. FIGS. 1 and 2 are examples for modeling the characteristic in which the target has the largest current direction-maintaining probability and has a moving probability that decreases as a direction further varies from a currently-proceeding direction. Other moving models having physical characteristics of the target having moving probabilities varying according to directions may also be used.

A normal distribution model will now be described. Since the moving probability of the target moving in a current direction is largest, the probability of moving to the direction θ is described as Equation 1.

$$p ( θ ) = \frac{1}{σ \sqrt{2 π}} exp ( - \frac{{θ}^{2}}{2 {σ}^{2}} ) \qquad ( 1 )$$

Since a turning angle of the target cannot be large when the target moves at high speed, the probability is further concentrated on the current direction as the moving speed of the target increases. Thus, dispersion σ² is reduced as the speed of the target increases. The linear mapping from the instant speed v of the target to the dispersion σ² is set by σ²=av+b, and Equation 1 can be expressed as Equation 2.

$$p ( θ ) = \frac{1}{\sqrt{2 π ( av + b )}} exp ( - \frac{{θ}^{2}}{2 ( av + b )} ) \qquad ( 2 )$$

Since the normal distribution model is an approximate model, an total probability on all the directions within a section [−π, π] is less than 1. However, it is assumed that probabilities with sections other than the section [−π, π] can be obtained when the target is stopped. In a linear distribution model, the probability of the target moving decreases linearly on a side direction and reaches a minimum when θ=π, which can be expressed as Equation 3.

$$p = ( \begin{matrix}a θ + b , & θ ∈ ( - π , 0 ] \\ - a θ + b , & θ ∈ ( 0 , - π ]\end{matrix} ) \qquad ( 3 )$$

Since an overall probability is 1

$$( i . e . , 2 {\int }_{0}^{π} ( - a x + b ) d x = 1 )$$

and a probability cannot be less than 0, p(θ=π)=−aπ+b≧0. Thus, the range of a and b can be set, and according to the present invention, a=(π−2)/(2π²) and b=¼ are used as an example.

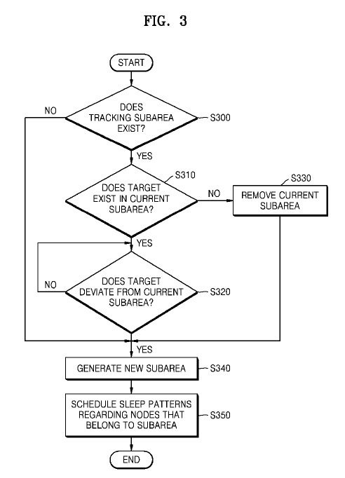

FIG. 3 is a flowchart illustrating operations of a method of managing a tracking subarea according to an embodiment of the present invention;

In order to proactively wake up neighboring nodes, root nodes broadcast an alert message, the position of a target, and speed information. The root nodes and all the proactively awakened nodes form the tracking subarea for a tracking operation. The present invention uses a circular tracking subarea of the target but uses an oval tracking subarea illustrated in FIG. 1 of the target.

When an included angle formed by a line connecting the target and the root nodes and a current instant velocity direction is θ, a radius d(θ) ranging from the root nodes to an edge of the subarea can be obtained using Equation 4. In other words, a radius d(θ=0) is largest when θ=0, and a radius in other directions is in proportion to d(θ=0).

$$d ( θ = 0 ) = m \cdot v \cdot p ( θ = 0 ) + n \\ d ( θ ) = \frac{p ( θ )}{p ( θ = 0 )} d ( θ = 0 ) \qquad ( 4 )$$

A proactive waking up action may be completed with a one-hop communication. Thus, d(θ=0)|ᵥ₌ᵥₘₐₓ≦d_{com} is set. In this regard, d_{com} is a radio frequency (RF) communication range of sensor nodes. When d(θ=0)|ᵥ₌ᵥₘₐₓ=d_{com} and d(θ=0)|ᵥ₌ᵥₘᵢₙ=dₘᵢₙ, vₘᵢₙ and dₘᵢₙ are referred to as a minimum speed and a minimum subarea radius, respectively. In this regard, m and n are proportional constants determined in the RF communication range of the sensor nodes and can be obtained using Equations 5 and 6 regarding each of the normal distribution model and the linear distribution model.

$$\begin{matrix}Normal Distribution Model \\ d ( θ ) = ( \frac{m \cdot v}{\sqrt{2 π ( av + b )}} + n ) exp ( - \frac{{θ}^{2}}{2 ( av + b )} ) \\ m = \frac{{d}_{com} - {d}_{min}}{\frac{{v}_{max}}{\sqrt{2 π ( {av}_{max} + b )}} - \frac{{v}_{min}}{\sqrt{2 π ( {av}_{min} + b )}}} \\ n = {d}_{com} - \frac{m \cdot {v}_{max}}{\sqrt{2 π ( {av}_{max} + b )}} & ( 5 ) \\ Linear Model \\ d ( θ ) = m \cdot v \cdot ( - a \vert θ \vert + b ) + n \\ m = \frac{{d}_{com} - {d}_{min}}{b \cdot ( {v}_{max} - {v}_{min} )} \\ n = {d}_{com} - c \cdot b \cdot {v}_{max} & ( 6 )\end{matrix}$$

In the present invention, it is determined whether the target deviates from the previous tracking subarea so as to proactively wake up neighboring nodes. In other words, when the target get close to the edge of the subarea, a node which detects the target and is positioned at the edge of the subarea, operates as a root node and broadcasts an alert message requesting neighboring nodes to prepare for tracking. When the subarea is not formed, a first node detecting the target acts as a root node and then forms the subarea of each of a plurality of nodes. In this case, the subarea is an oval subarea illustrated in FIG. 1, having root nodes set to basic points and having the scope set using Equations 1 to 6.

The method of managing the tracking subarea will now be described in detail with reference to FIG. 3.

When the tracking subarea does not exist in operation S300, a new subarea is formed based on the radius d(θ) in operation S340. When the tracking subarea exists in operation S300, it is checked whether the target exists in a current subarea in operation S310. When the target does not exist in the tracking subarea in operation S310, the current subarea is removed in operation S330, and a new subarea is formed in operation S340. When the target exists in the tracking subarea in operation S310, whether the target deviates from the subarea is continuously tracked in operation S320.

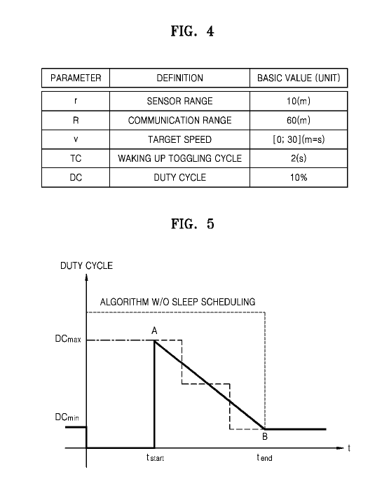

FIG. 4 illustrates an example of parameters of sleep levels of sensor nodes according to an embodiment of the present invention.

The sleep levels of sensor nodes may be represented as a series of sleep states, i.e., {Sᵢ|iε[0,k−1]}. In this regard, S₀ represents an awake state, and Sₖ₋₁ represents a deepest sleep state. The number of the sleep levels may vary according to the situation of the present invention. For example, the sleep levels may comprise two states such as an awake, active state and a waiting, sleep state. The sleep levels may be specified using parameters illustrated in FIG. 4. For example, each of the sleep levels may vary according to parameters such as a tracking range r of the sensor nodes, a communication range R, target speed v, a waking up toggling cycle (TC), a duty cycle (DC), etc.

FIG. 5 illustrates an example of a duty cycle for sleep scheduling based on directions of a target in a sensor network according to an embodiment of the present invention.

In the present invention, the state of each sensor node is classified into a surveillance state in which the target is not observed, and a tracking state in which the target is tracked when the target enters the area of the sensor node. All sensor nodes have random sleep patterns in the surveillance state. In other words, although all of the sensor nodes have a same toggling cycle (TC) and a same duty cycle (DC), each of the sensor nodes selects the start time of the toggling cycle (TC) randomly and independently. Thus, the active state in which each of the sensor nodes is woken up is maintained during a period of TC×DC, and the sleep state is maintained during a period of TC×(1−DC). A sleep scheduling algorithm according to the present invention may be applied to the tracking state.

Referring to FIG. 5, the X-axis represents time, and the Y-axis represents the duty cycle (DC). DCₘₐₓ represents a maximum DC value of the sensor nodes, and tₛₜₐᵣₜ represents the start time of scheduling according to the present invention or a minimum time at which the target enters the sensing region of each of the sensor nodes in a current position, and t_{end} represents the end time of scheduling. DCₘₐₓ, tₛₜₐᵣₜ, and t_{end} are determined based on the above-mentioned d(θ), v, and P(θ).

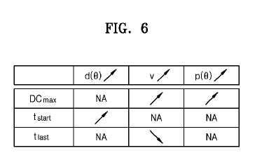

Specifically, the higher the speed of the target is, the longer the sensor nodes must be maintained in an active state so as to catch the target (DCₘₐₓ:v). The larger the target moving probability in a specific direction is, the longer the sensor nodes must be maintained in an active state (DCₘₐₓ:p(θ)). The farther the sensor nodes from the current position of the target are, the longer the sensor nodes can be maintained in a sleep state until the target arrives (tₛₜₐᵣₜ:d). The faster the target moves, the shorter the sensor node need to keep its high duty cycle, because the target is supposed to pass by very fast (t_{end}:v). This will be summarized as illustrated in FIG. 6. Here, tₗₐₛₜ=t_{end}−tₛₜₐᵣₜ.

Each of the parameters illustrated in FIG. 5 will now be described in consideration of the characteristics of parameters illustrated in FIG. 6.

(1) DCₘₐₓ

DCₘₐₓ increases as the instant speed of the target increases and a probability in the direction of the instant speed of the target increases. Thus, DCₘₐₓ=i·v·p(θ=0)+j, and when DCₘₐₓ is linear to parameters v and p(θ) when parameters other than v and p(θ) are constant. Thus, DCₘₐₓ can be represented as a normal distribution model and a linear distribution model by using Equations 7 and 8.

$$\begin{matrix}{DC}_{max} = \frac{i \cdot v}{\sqrt{2 π ( av + b )}} exp ( - \frac{{θ}^{2}}{2 ( av + b )} ) + j \\ i = \frac{{DC}_{max} {\vert}_{max} - j}{v \cdot p ( θ ) {\vert}_{θ = 0 , v = {v}_{max}}} = \frac{1 - \frac{2 {P}_{switch}}{T C \cdot ( {P}_{sense} - {P}_{sleep} )} - j}{\frac{{v}_{max}}{\sqrt{2 π ( {av}_{max} + b )}}} \\ j = {DC}_{max} {\vert}_{θ = 0 , v = {v}_{max}} = {DC}_{min} & ( 7 ) \\ {DC}_{max} = i \cdot v \cdot ( - a \vert θ \vert + b ) + j \\ i = \frac{{DC}_{max} {\vert}_{max} - j}{v \cdot p ( θ ) {\vert}_{θ = 0 , v = {v}_{max}}} = \frac{1 - \frac{2 {P}_{switch}}{T C \cdot ( {P}_{sense} - {P}_{sleep} )} - j}{b \cdot {v}_{max}} \\ j = D {C}_{max} {\vert}_{θ = 0 , v = {v}_{max}} = {DC}_{min} & ( 8 )\end{matrix}$$

In Equations 7 and 8, Pₛₑₙₛₑ represents an energy consumption rate in the sensor nodes in an active state, and P_{send} represents an energy consumption rate when the sensor nodes send a message, and P_{rcv} represents an energy consumption rate when the sensor nodes receive a message, and P_{switch} represents an energy consumption rate when the state of the sensor nodes is changed into a wake up/sleep state.

(2) tₛₜₐᵣₜ

tₛₜₐᵣₜ is a maximum time at which nodes can be maintained in a sleep state before the target enters the sensing range of the sensor nodes. In addition, tₛₜₐᵣₜ is a minimum time taken by the target to reach the sensing region of the sensor nodes at maximum speed. Thus, tₛₜₐᵣₜ can be obtained using Equation 9.

$${t}_{start} = \frac{d - r}{{v}_{max}} \\ ( 3 ) {t}_{end} \qquad ( 9 )$$

t_{end} is a maximum time at which the target deviates from the sensing region of the sensor nodes. However, when the target moves outside a current subarea within a shorter time than expected, sleep scheduling must be restored to its original state. Thus, t_{end} can be obtained using Equation 10.

$${t}_{end} = min \{ \frac{d + r}{{v}_{min}} , {t}_{out} \} \qquad ( 10 )$$

, where vₘᵢₙ is not the minimum speed 0 of the target but is v/2. tₒᵤₜ is a point of time when the target deviates from a current tracking subregion.

(4) Line AB

A line equation regarding the line AB of Equation 11 can be obtained by using DCₘₐₓ, tₛₜₐᵣₜ, and t_{end}, which are obtained as described above.

DC=at+b (11)

DCₘₐₓ and DCₘᵢₙ can be applied to Equation 11, which results in Equation 12.

DCₘₐₓ=a·tₛₜₐᵣₜ+b

DCₘᵢₙ=a·t_{end}+b

Constants a and b in the normal distribution model can be obtained using Equation 13, and constants a and b in the linear distribution model can be obtained using Equation 14.

$$\begin{matrix}a = - \frac{D {C}_{max} - D {C}_{min}}{{t}_{end} - {t}_{start}} = \frac{\begin{matrix}\frac{\sqrt{{av}_{max} + b}}{\sqrt{av + b}} \cdot ( 1 - \frac{2 {P}_{switch}}{T C \cdot ( {P}_{sense} - {P}_{sleep}} - D {C}_{min} ) \cdot \\ \frac{v}{{v}_{max}} \cdot exp ( - \frac{{θ}^{2}}{2 ( av + b )} )\end{matrix}}{\frac{d + r}{{v}_{min}} - \frac{d - r}{{v}_{max}}} \\ b = {DC}_{max} - {at}_{start} = \frac{{DC}_{max} \cdot {t}_{end} - {DC}_{min} \cdot {t}_{start}}{{t}_{end} - {t}_{start}} & ( 13 ) \\ a = - \frac{{DC}_{max} - {DC}_{min}}{{t}_{end} - {t}_{start}} = \frac{\begin{matrix}\frac{1}{b} \cdot ( 1 - \frac{2 {P}_{switch}}{T C \cdot ( {P}_{sense} - {P}_{sleep} )} - {DC}_{min} ) \cdot \\ \frac{v}{{v}_{max}} \cdot ( - a \vert θ \vert + b )\end{matrix}}{\frac{d + r}{{v}_{min}} - \frac{d - r}{{v}_{max}}} \\ b = \frac{D {C}_{max} - {at}_{start} = D {C}_{max} \cdot {t}_{end} - D {C}_{min} \cdot {t}_{start}}{{t}_{end} - {t}_{start}} & ( 14 )\end{matrix}$$

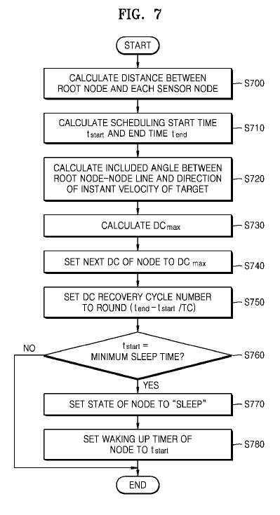

FIG. 7 is a flowchart illustrating operations of a sleep scheduling method based on directions of a target in a sensor network according to an embodiment of the present invention.

A distance between a root node of a subarea and each sensor node that is woken up is calculated in operation S700. Since the positions of nodes in the sensor network are already known, the distance between sensor nodes can be obtained only when a user knows a corresponding sensor node. The distance between sensor nodes can be obtained using various conventional methods, and thus a detailed description thereof will be omitted here.

In addition, it is assumed that each sensor node can determine the position and speed of the target. The position and speed of the target can be determined using conventional various methods. When the position and speed of the target are known, each sensor node calculates a start time tₛₜₐᵣₜ and an end time t_{end} of scheduling according to the present invention in operation S710.

An angle θ formed by the direction of a line connecting a root node and each sensor node and the direction of the instant velocity of the target is obtained in operation S720. A maximum value DCₘₐₓ of the duty cycle (DC) of each node is obtained in operation S730. Each sensor node sets the maximum value DCₘₐₓ to a next duty cycle (DC) value in operation S740, and a duty cycle recovery cycle number of each node is set to a value of

$$Round ( \frac{{t}_{end} - {t}_{start}}{T C} )$$

in operation S750. In this regard, Round( ) is a rounding function, and TC is an initial waking up toggling cycle (TC).

The DC of each sensor node set according to the present invention reaches a maximum value at tₛₜₐᵣₜ, as illustrated in FIG. 5, and decrease linearly to a basic duty cycle (DC) of a sensor node at t_{end}. If the DC recovery cycle number is equal to or greater than 2, each sensor node is maintained in an active state during a DC corresponding to a TC start time of each sensor node between t_{end} and tₛₜₐᵣₜ. That is, if tₛₜₐᵣₜ obtained at each node is “minimum_sleep_time” in operation S760, “SLEEP” state is set in operation S770, and a waking up timer is reset to tₛₜₐᵣₜ in operation S780.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion.

According to the present invention, sleep patterns of each sensor node are scheduled in consideration of a moving probability according to the speed of a target and directions of the target, such that the number of sensor nodes in an awake state is reduced compared to the related art and the awake time of each sensor node is reduced and the energy efficiency of the nodes in a sensor network is improved.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A sleep scheduling method based on directions of a target regarding sensor nodes sensing a position and a speed of the target in a sensor network comprising the sensor nodes, the method comprising:
setting a tracking subarea to track the target so that a distance between contour line of the tracking subarea and sensor nodes sensing the target are in proportion to a probability of the target moving in directions; and
scheduling sleep patterns of the sensor nodes in the tracking subarea.

2. The method of claim 1, wherein the setting of the tracking subarea comprises setting the tracking subarea so that a distance between a contour line of the tracking subarea and the sensor nodes sensing the target are in proportion to a probability of the target moving in directions and the speed of the target.

3. The method of claim 1, wherein the setting of the tracking subarea comprises setting an oval tracking subarea.

4. The method of claim 1, wherein a probability of the target moving in directions is the largest in the same direction as a current moving direction of the target and is the smallest in an opposite direction to the current moving direction of the target.

5. The method of claim 1, further comprising, if the target is closer to an edge of the tracking subarea, setting a new tracking subarea having a contour line in which a distance proportional to a probability of the target moving in directions is spaced apart from a sensor node sensing the target at the edge.

6. The method of claim 1, wherein the sensor nodes sensing the target are sensor nodes positioned to be nearest to the target.

7. The method of claim 1, further comprising, if the target deviates from the tracking subarea, releasing the tracking subarea.

8. A sleep scheduling method in a sensor network comprising sensor
nodes sensing a position and a speed of the target, the method comprising:
obtaining a distance between a sensor node positioned in a tracking subarea set based on a probability of the target moving in directions and a root node sensing the target;
obtaining a minimum time at which the target reaches a sensing region of the sensor node, based on the distance;
obtaining an angle formed by the direction of a line connecting the root node and the sensor node and the direction of an instant velocity of the target;
setting a maximum duty cycle (DC) that is in proportion to a probability of the target moving in direction corresponding to the angle and the speed of the target, to a DC of the target; and
if the sensor node is maintained in a sleep state for a minimum time and reaches the minimum time, maintaining an active state during a DC set for the target.

9. The method of claim 8, further comprising:
obtaining a maximum time at which the target passes the sensing region of the sensor node, based on the speed of the target;
decreasing the DC of the target from the maximum DC to a basic DC during the period between the minimum time and the maximum time and if a basic toggle cycle (TC) of the target occurs during the period, obtaining the DC of the target corresponding to a start time of the TC; and
maintaining the sensing node in an active state during the obtained DC.

10. The method of claim 9, further comprising, if the target deviates from the tracking subarea, setting a DC of the target to a basic DC.

11. The method of claim 9, wherein the obtaining of the maximum time comprises obtaining the maximum time by dividing a value, obtained by adding a radius of the sensor node to the distance, into the minimum speed of the target (not 0).

12. The method of claim 8, wherein the obtaining of the minimum time comprises obtaining the minimum time by dividing a value, obtained by subtracting the radius of the sensor node from the distance, into the maximum speed of the target.
